(19) United States
(12) Patent Application Publication
(10) Pub. No.: US 2005/0035077 A1
(43) Pub. Date: Feb. 17, 2005

(54) Crane comprising a telescopic jib, a cable winch and a regulating device

(76) Inventor: Erich Wimmer, Eggelsberg (AT)

Correspondence Address: WENDEROTH, LIND & PONACK, L.L.P., 2033 K STREET N. W., SUITE 800, WASHINGTON, DC, 20006-1021, US

(21) Appl. No.: 10/917,379

(22) Filed: Aug. 13, 2004

(30) Foreign Application Priority Data
Aug. 14, 2003 (AT) A 1280/2003

(51) Int. Cl. B66C 23/26

(52) U.S. Cl. 212/276

(57) ABSTRACT

A crane comprising a telescopic, in particular articulated jib, a cable winch and a direction-changing roller arranged at the tip of the jib for a lifting cable from which a load-carrier means, for example a hook, is suspended, and a regulating device for synchronizing the rotary movement of the cable winch with the telescopic or articulation movements of the jib, wherein the crane (1) has a measuring device (14) for detecting the position and the speed of revolution respectively of the direction-changing roller (4).

The invention concerns a crane comprising a telescopic, in particular articulated, jib, a cable winch and a direction-changing roller arranged at the tip of the jib for a lifting cable from which a load-carrier means, for example a hook, is suspended, and a regulating device for synchronizing the rotary movement of the cable winch with the telescopic or articulation movements of the jib.

The problem which arises in connection with cranes with telescopic or articulated jibs is that the load on the cable is raised or lowered in the extension or retraction movement of the jib or upon articulation thereof. In the case of cranes with a telescopic jib, which have a pulley block assembly for the telescopic jib, it is already known to cause the load-carrier means to describe a horizontal path by precise calculation of the number of strands for the pulley block assembly and the number of strands for the load-carrier means.

EP 1 291 312 provides two measuring devices for determining the actual values as input parameters for the synchronization procedure, wherein one measuring device monitors how far the jib is extended and the other measures the extent to which the lifting cable is moved. With that crane therefore, at least two measuring sensors are necessary for the desired synchronization effect, which on the one hand involves an increase level of maintenance expenditure and on the other hand requires a complex synchronization procedure.

The object of the invention is to provide a crane of the general kind set forth having as few sensors as possible and a suitable synchronization procedure which is as simple as possible.

According to the invention that is achieved in that the crane has a measuring device for detecting at least one actual value selected from the group consisting of the position of the direction-changing roller and the speed of revolution of the direction-changing roller.

In that way it is possible for the cable movement to be detected both in respect of direction and also in respect of magnitude, at the direction-changing roller which is closest to the load along the lifting cable and which is arranged at the tip of the jib. By virtue of the fact that the direction-changing roller which is arranged most closely to the load is used for detecting speed and position respectively, all crane movements which alter the length, inclusive of additional articulation systems, can be compensated by suitable tracking adjustment and control of the cable winch, using only one measuring device. In other words, if the cable length is altered by way of a telescopic or an articulation movement of the jib, synchronization of the rotary movement of the cable winch with the telescopic or articulation movements of the jib takes place on the basis of the movement of the cable at the direction-changing roller at the tip of the jib, by means of the regulating device, so that the load-carrier means substantially maintains for example its spacing from the direction-changing roller. In accordance with a further embodiment of the invention accurate adjustment of the cable winch can be achieved if the regulating device has at least one electronic regulator, preferably a PID-regulator.

If a change in the cable length is desired, independently of possible movements of the crane, then in accordance with a further embodiment of the invention the regulating device can have an input device connected to a regulator for presetting reference values to the regulator.

A particularly simple possible way of establishing the cable movement at the direction-changing roller is afforded if the direction-changing roller has a plurality of bores which are arranged at regular spacings from each other on a circular path, wherein the center point of the circular path is on the axis of rotation of the direction-changing roller, and the measuring device has at least two preferably inductive sensors for detecting the position of the bores. In that way it is possible to infer the direction of rotation of the direction-changing roller from the succession of the signal transitions, it is possible to infer the position of the roller from the number of pulses and it is possible to infer the rotary speed of the roller from the number of pulses per second.

In order to obtain two 90°-shifted signals by means of the sensors, a further embodiment of the invention can provide that the diameter of the bores corresponds to half the distance that the center points of the bores have from each other.

In addition the invention seeks to provide a method of synchronizing the rotary movement of a cable winch with the telescopic or articulation movements of a jib of a crane, wherein for example the spacing of the load-carrier means from the direction-changing roller arranged most closely adjacent to the load is kept substantially constant.

A method of that kind is characterized in that the cable movement is detected in respect of direction and magnitude at the direction-changing roller at the tip of the jib by means of the measuring device and passed as an actual value to the regulator. In accordance with a preferred embodiment of the method of the invention the regulator, in dependence on the detected actual value, preferably having regard to a reference value, ascertains a setting value for control of the rotary movement of the cable winch in order to compensate for a change in the spacing of the load-carrier means from the direction-changing roller as a consequence of a telescopic or an articulation movement of the jib.

In other words, the actual position of the cable roller is detected in dependence on direction by a counter and the actual speed is calculated therefrom by differentiation in respect of time of the counter condition. The difference between the actual speed and the reference speed, which in accordance with a further embodiment of the invention can be preset for the regulator by means of an input device, is calculated as the regulating deviation and then applied as a setting value to a hydraulic valve for controlling the rotary movement of the cable winch, and possibly linearizes the characteristic curve of the hydraulic valve.

Further advantages and details of the invention are described in greater detail hereinafter with reference to the Figures of the drawing in which:

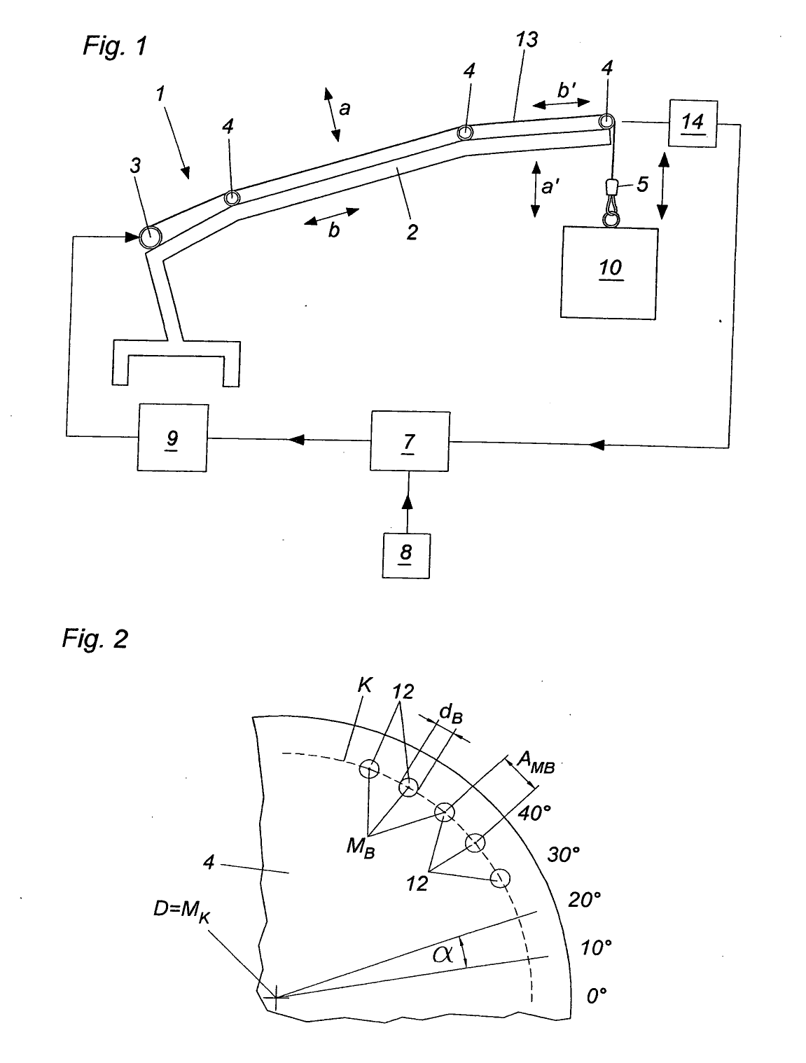

FIG. 1 shows a block diagram of a crane according to the invention,

FIGS. 2 to 4 show details of the measuring device together with the direction-changing roller, and

FIG. 5 diagrammatically shows the procedure involved in a regulating operation.

The crane 1 has a telescopic and articulated jib 2. The lifting cable 13 is wound on the cable winch 3 and is guided along the jib 2 by way of a plurality of direction-changing rollers 4 to the tip of the jib 2. A load-carrier means 5, for example in the form of a hook, is arranged at the free end of the lifting cable 13. The load is denoted by reference 10. The jib 2 of the crane 1 can perform both articulation movements a, a′ and also thrust movements b, b′. The movement of the lifting cable 13 is detected in respect of direction and magnitude by means of a measuring device 14, at the direction-changing roller 4 which is closest to the load. Those actual values are fed to a regulator 7 which, preferably having regard to reference values which can be inputted into the regulator 7 by way of an input device 8, converts them into a setting value for a hydraulic valve 9 by means of which the rotary movement of the cable winch 3 is controlled.

If a reference speed is preset by the user for the cable winch, the system is regulated to a roller speed which is proportional to that reference value. It has been found that all crane movements which alter the cable length can be particularly easily compensated by suitable tracking adjustment of the cable winch when the direction-changing roller which is arranged closest to the load is used for speed detection purposes. If a change in the cable length is wanted by reference value presetting, then the cable winch can be regulated to a cable winch rotary speed corresponding to the reference value, independently of the other crane movements which alter the cable length.

FIG. 2 shows a portion of a direction-changing roller 4 according to the invention, from which it will be seen that the direction-changing roller 4 has a plurality of bores 12 which are arranged at regular spacings, for example every 10°, on a circular path K. In this case the center point M_{K} of the circular path K is on the axis of rotation D of the direction-changing roller 4. In the illustrated embodiment the diameter d_{B} of the bores 12 corresponds to half the distance A_{MB} that the center points M_{B} of the bores 12 have from each other

$$( {d}_{B} = \frac{{A}_{MB}}{2} ) .$$

.

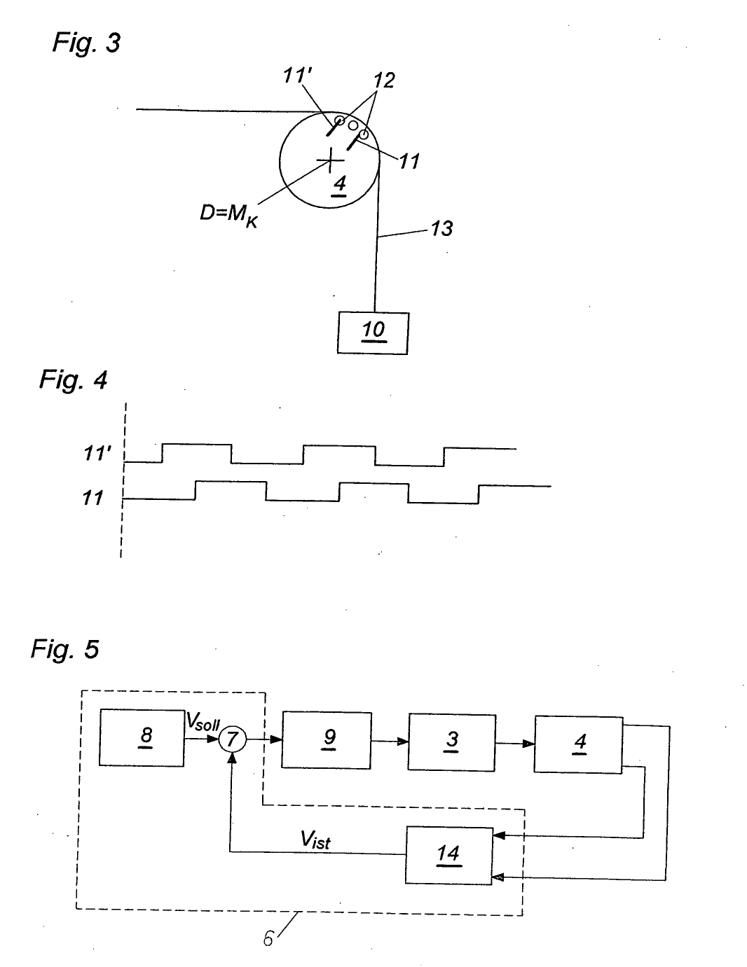

With such an arrangement of the bores 12 on the direction-changing roller 4, that produces two 90°-shifted signals (FIG. 4) if, as shown in FIG. 3, the measuring device has two sensors 11, 11′ which for example can be in the form of inductive proximity switches, wherein, whenever a sensor 11′ faces towards the center of a bore 12, the second sensor 11 points towards the edge of a bore 12. By virtue of those two 90°-shifted signals, the direction of rotation of the direction-changing roller can be inferred from the succession of the signals, the position of the roller can be inferred from the number of pulses and the speed of rotation of the roller can be inferred from the number of pulses per second.

FIG. 5 shows a diagrammatic representation of a regulating procedure. In this case the regulating device 6 includes a regulator 7, a measuring device 14 and optionally an input device 8. In the case synchronous regulation of the rotary movement of the cable winch 3 with the telescopic/articulation movements of the jib includes the following steps: by means of the measuring device 14, the actual position of the direction-changing roller 4 is detected in dependence on direction by way of the sensors and a counter. The actual speed of the direction-changing roller 4 is calculated by differentiation in respect of time of the counter condition. That calculated actual speed V_{ACT} is fed to the electronic regulator 7. Equally, a reference speed V_{REF} for the cable winch 3 can be predetermined by way of the input device 8 for the regulator 7, for example by way of a joystick or by way of a radio remote control. Then, the regulating deviation is calculated in the regulating device 6 from the difference between the actual speed and the reference speed, and applied as a setting value to a hydraulic valve 9 for controlling the cable winch 3, before the characteristic curve of the hydraulic valve 9 is linearized. The subsequent rotary movement of the cable winch 3 in turn causes a rotary movement of the direction-changing roller 4 whose new actual position is in turn subsequently detected in dependence on direction by way of the measuring device 14.

It will be appreciated that the invention is not limited to the illustrated embodiments. Thus, instead of the PID-regulator which is preferably employed, it would certainly be possible to use other electronic regulators. The same applies in regard to the inductive sensors. What is essential to the invention in contrast is detection of the rotary movement of the direction-changing roller for the lifting cable at the tip of the jib, in respect of direction and magnitude. A basic idea of the invention is therefore represented by detection of the rotary movement of the direction-changing roller which is closest to the load along the lifting cable.

1. A crane comprising a telescopic jib, a cable winch and a direction-changing roller arranged at the tip of the jib for a lifting cable from which a load-carrier means is suspended, and a regulating device for synchronizing the rotary movement of the cable winch with the telescopic or articulation movements of the jib, characterized in that the crane has a measuring device for detecting at least one actual value selected from the group consisting of the position of the direction-changing roller and the speed of revolution of the direction-changing roller.

2. A crane as set forth in claim 1 characterized in that the measuring device is designed or arranged for detecting the actual value at the direction-changing roller which is arranged closest to the load.

3. A crane as set forth in claim 1 characterized in that the regulating device has at least one electronic regulator.

4. A crane as set forth in claim 3 characterized in that the electronic regulator is a PID-regulator.

5. A crane as set forth in claim 1 characterized in that the direction-changing roller has a plurality of bores arranged at regular spacings from each other on a circular path, wherein the center point of the circular path is on the axis of rotation of the direction-changing roller.

6. A crane as set forth in claim 5 characterized in that the diameter of the bores corresponds to half the distance that the center points of the bores have from each other.

7. A crane as set forth in claim 5 characterized in that the measuring device has at least two sensors for detecting the position of the bores.

8. A crane as set forth in claim 7 characterized in that the sensors are inductive sensors.

9. A crane as set forth in claim 1 characterized in that the jib is articulatable.

10. A method of synchronizing the rotary movement of a cable winch with the telescopic or articulation movements of a jib of a crane, wherein a direction-changing roller for a lifting cable is arranged at the tip of the jib and a load-carrier means is arranged at the lifting cable, characterized in that the cable movement is detected in respect of direction and magnitude at the direction-changing roller by means of a measuring device and passed as an actual value to a regulator.

11. A method as set forth in claim 10 characterized in that in dependence on the detected actual value the regulator ascertains a setting value for control of the rotary movement of the cable winch in order to compensate for the change in the spacing of the load-carrier means from the direction-changing roller as a consequence of a telescopic or an articulation movement of the jib.

12. A method as set forth in claim 11 characterized in that the rotary movement of the cable winch is controlled by way of a hydraulic valve.

13. A method as set forth in claim 11 characterized in that the setting value is ascertained by the regulator, having regard to a reference value.
